(19) United States
(12) Patent Application Publication
(10) Pub. No.: US 2015/0210346 A1
(43) Pub. Date: Jul. 30, 2015

(54) Arm Actuated Brake Lever for Quadriplegic

(71) Applicants: Michael Shane Lofgren, Tualatin, OR (US); Brian Charles Stewart, Oregon City, OR (US)

(72) Inventors: Michael Shane Lofgren, Tualatin, OR (US); Brian Charles Stewart, Oregon City, OR (US)

(21) Appl. No.: 14/166,638

(22) Filed: Jan. 28, 2014

(51) Int. Cl. B62L 3/02; B62M 1/14

(52) U.S. Cl. CPC B62L 3/02; B62M 1/14

(57) ABSTRACT

The invention relates to an arm actuated lever for a multiwheeled cycle. In the preferred embodiment, the invention is a braking system including a braking means associated with one or more of the wheels of the cycle and a brake lever for the purpose of engaging the braking means which is attached to the hand pedal of the bike in a manner that permits the brake lever to be engaged by the operator's wrist or forearm for use by quadriplegics. . The brake lever is further configured to rotate with the hand pedals and crank arms of the cycle which are engaged by the rider's hands through the pedals. The invention permits the cranks to rotate forwardly to deliver power to the wheels and to freewheel in an opposite rotation to permit free coasting. Movement of the operator's wrist and or forearm provides movement to the brake lever engaging the braking means and stopping of the handcycle.

The invention herein relates to handcycles which are generally manually powered cycles, powered by the operator's hands. Often but not always handcycles are operated by individuals with some type of paraplegia or other bodily impairment that precludes them from using their legs as a source of power to drive the cycle. In the particular case of the invention the handcycle is to be facilitated with a braking system that will permit individuals with high level injuries commonly know as quads to operate and stop the handcycle by engaging the brake or brakes with movement of their forearm or wrist.

Prior to the present invention, quads had great difficulty applying the brakes on a handcycle. This is because quads have very limited grip with their hands. Because of the nerve damage at the spinal cord injury site, which in a quad is in the cervical area of the spinal column, the ability to grip with strength in the fingers is diminished. This condition varies from person to person and by injury location and completeness of spinal degradation. Some quads will have the ability to squeeze a brake lever with their grip and some will not. The invention disclosed herein is for individuals who have had their ability to grip with their hands diminished to point where applying a braking effort to the handcycle by means of their finger grip is not adequate to stop the vehicle.
Quadriplegic injuries are the most common form of spinal cord injury and often occur from auto accidents, sporting injuries, surgeries, tumors and other trauma. Spinal injuries are classified as complete or incomplete and the distinctions between the two can vary dramatically. A person with a quadriplegic injury may have very different dexterity in their hands than another with an injury in a similar spinal location. The present invention is directed at those individuals that have impaired use of their grip to the extent that they can not safely and adequately squeeze a brake lever with their hands to effectively stop a hand powered cycle.

Although a person with a quadriplegic spinal injury may be unable to grip and squeeze a brake lever with their hands and fingers they will generally have the ability to control the movement of their wrists and forearms. Quadriplegics generally have the ability to effect movement of their forearms and wrist either toward each other or away from each other. The best way to describe this motion it to envision the quad seated in the cycle with hands secured to the pedals by some means. Here it will be informative to provide insight into the means by which a quadriplegic engages the pedals without the benefit of gripping with the hands and fingers.

There has long been an understanding that hand grip among quads was insufficient to successfully grip a pedal with their fingers to provide rotation to the crank arms to power a handcycle. This is another manifestation of the same problem that makes braking with the hands and fingers not possible. In order to permit a quad to engage the pedals a series of devices were developed to enable the quad to engage the pedals without relying on finger grip. This is accomplished in several ways. One, incorporates one manner of glove or another that the quad wears on their hands that has various means of engaging the pedals. It may consist of a male and female type of connection where the male or female part will be part of the glove or pedal and when engaged, the quad's hands constrained by the gloves, are further constrained by the male-female interface and power is able to be delivered to the pedals. This type of connection to the pedals incorporates some type of quick engagement and separation so that the quad can quickly remove and engage their hands with the pedals.

Several means of engaging the quad's hands with the pedals are presently available on the market and work well. Some devices also include the ability to place a shifting mechanism on the hand pedal so that the quad can accommodating shifting by moving the backs of their hands to engage and move the shift lever to enact shifting. The present invention recognizes the common use of this type of device and generally incorporates some type of hand engagement or entrapment device to secure the rider's wrist to the pedals.

Once the rider's hands are releasably secured to the pedals, the rider can move their arms together or apart to engage the brake lever of the present invention and enact braking of the handcycle.

The need to provide a means of braking a handcycle for quads has long been recognized and there are various complex devices available to accomplish this task. All of them have draw backs that the present invention overcomes.

The most common approach to stopping a handcycle for quadriplegics is to configure the cranks arms so that the brake is engaged when the crank arms are rotated backwards and some type of device is engaged by means of a lever or combination of releasable lever and pin so that when pedaled backwards the brake mechanism is engaged and the handcycle stops. These devices have inherent problems that the present invention overcomes.

Most hand powered cycles use standard bicycle components because they are relatively inexpensive, effective and readily available. The power train generally, as on most bicycles, includes a freewheel so that the rider can coast without having to pedal and when coasting the crank arms stop rotating. This is a very important feature in cycling and creates the problem for the quad braking systems presently on the market. The problem occurs when the bike is stationary with the brakes applied or when the bike is rolling backwards on level ground or on a hill. When a cycle configured with a freewheel rolls backward the crank arms follow with a backward rotation. This happens with all freewheel configured cycles; bicycles and handcycles. Herein lies the problem with the existing back pedal braking devices; when the bike rolls backwards and the crank arms rotate backwards the existing devices engage the brakes and stop the handcycle. If the rider is on a hill and does not have the strength to continue pedal forward which is common, then the bike begins to roll backward, the brakes engage, the bike stops, the rider can not overcome the steepness of the hill and is stuck with the brakes engaged and the bike locked in place.

A relatively ingenious but somewhat complex solution to this problem has been developed by Bike-On.com which includes all of the mechanism described above with all the accompanying problems but the lockout situation is partially solved by the addition of a roller clutch, multiple levers, a release pin and a means to disengage the brakes when the cranks are desired to be free to rotate backwards such as when rolling backward on level ground. This device still does not prevent the rider from getting stuck on a hill if the rider is not strong enough to pedal up hill. Because the crank arms are either engaged by the pin or not engaged the crank arms either can not apply the brakes or have to apply the brakes. There is in between position or situation. Therefore the rider is either strong enough to pedal up the hill without stopping or the rider becomes stuck. The situation becomes even more difficult for a quad with his hands to some extent attached to the pedals because he can not quickly or easily disengage his hands to engage or release the locking pin to engage or release the braking mechanism.

The present invention overcomes and solves the above described problem of brake lock-up on a hill completely. The present invention is inexpensive and effective. The present invention does not permit the rider to become stuck on a hill. It lets the bike roll backwards on level grounds with the crank arms able to rotate rearwards without constraint as a conventional cycle.

The present invention overcomes the hill lockout problem because the brakes are engaged by the operator's wrist and not by the counter or rearward rotation of the crank arms. When on a hill or in any situation the rider is free to pedal the crankarms forwardly or rearwardly, to half pedal by rotating the crankarms 180 degrees backwards and then 180 degrees forward in a ratcheting manner or any combination of forward rearward rotations desirable and still apply the brakes at any time by moving their wrists or forearms inwardly or outwardly depending on the position of the brake lever relative to the rider's forearms and wrists. The advantage of being able to apply the brake independently of the rotation of the crank arms and not need to rely on finger strength to squeeze a brake lever is a tremendous improvement to a handcycle for a quad.

### OPERATION OF THE INVENTION

Although the invention would offer benefit to multi-wheeled cycles other than handcycles in the preferred embodiment the operation of the invention is as follows. The rider is seated on the cycle with legs supported and hands gripping the hand pedals. Rotation of the pedals provides power to the drive train which in turn drives at least one wheel of the cycle and the cycle is placed in motion. There may exist on some cycles auxiliary power provided by some type of motor either integrated with the cycle as in a hub motor or motor that engages the drive train by some means or an external propulsion source that pushes the cycle from the rear.

Once in motion the ability to stop or slow the cycle rests with the rider. In the case of a quadriplegic, stopping the vehicle is sometimes more difficult and a more critical factor in the operation of the cycle than propelling the cycle. In the present invention the ability to slow or stop the cycle is greatly facilitated by the forearm/wrist means of engagement of the brake lever. Moving the forearms together or apart is a motion that is available to most quadriplegics whereas constriction of the fingers in a gripping motion may or may not be available to many quadriplegics.

The inability to apply braking pressure to a standard brake lever system as configured for able-bodied people on a standard bicycle is one of the main reasons that quadriplegics have a difficult time riding a hand powered cycle or handcycle as they are now commonly know in the cycling community. The present invention address this long held problem and overcomes it.

When the rider needs to slow or stop the vehicle he is able to move his arms and wrist either inwardly or outwardly at any position of the rotation of the crank arms, engage the brake lever and continue to move his arms inwardly or outwardly levering the brake lever against its pivot point, pulling the brake cable and engaging the braking mechanism and slowing or stopping the cycle. The invention will work equally well with mechanical or hydraulic brakes. The invention will work for any rider but is intended for riders with impaired grip strength such as quadriplegics.

The rider can rotate the crank arms backwardly at any time or the crank arms are able to freewheel backwards if the rider and cycle are backing up or rolling down hill backwards as is the case on a cycle configured with a freewheel. This ability to permit the crank arms to rotate backward or freewheel is very important. This will permit the rider to avoid becoming stuck on a hill because the rider can always feather the brakes with his wrist and forearm while rolling backwards down the hill until he reaches level ground. A back pedal brake that engages the brakes by pedaling the crank arms backwards will sometimes cause the rider to become stuck on a hill as explained earlier.

### DESCRIPTION OF THE INVENTION

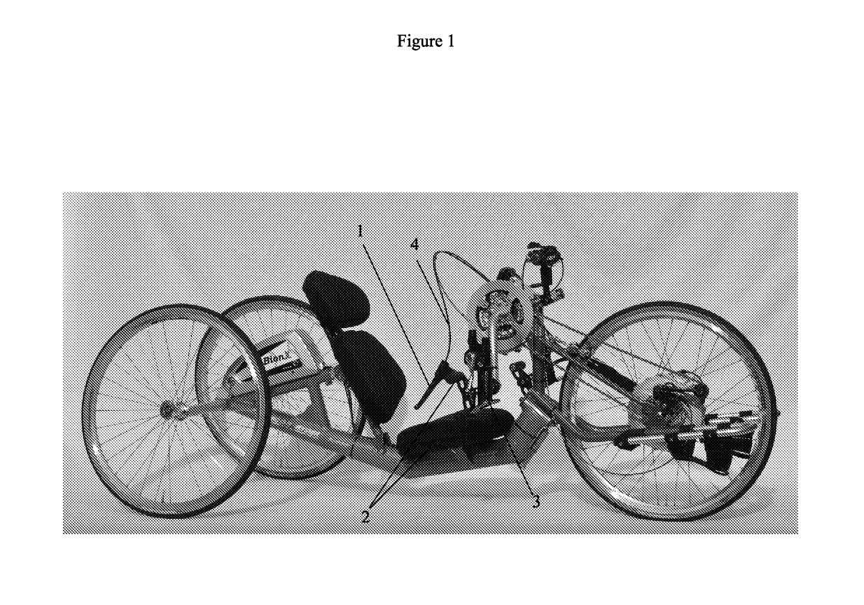

FIG. 1. shows a side view of the present invention attached to the right hand pedal of a motorized handcycle.

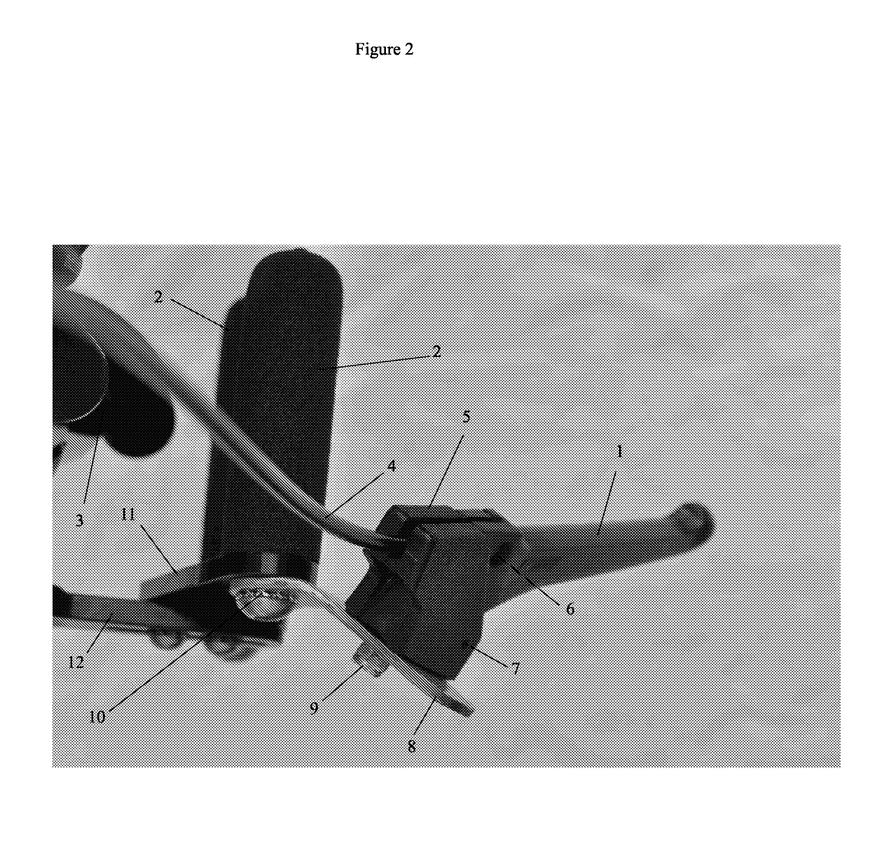

FIG. 2. shows the mounting means of the brake lever to the handgrip.

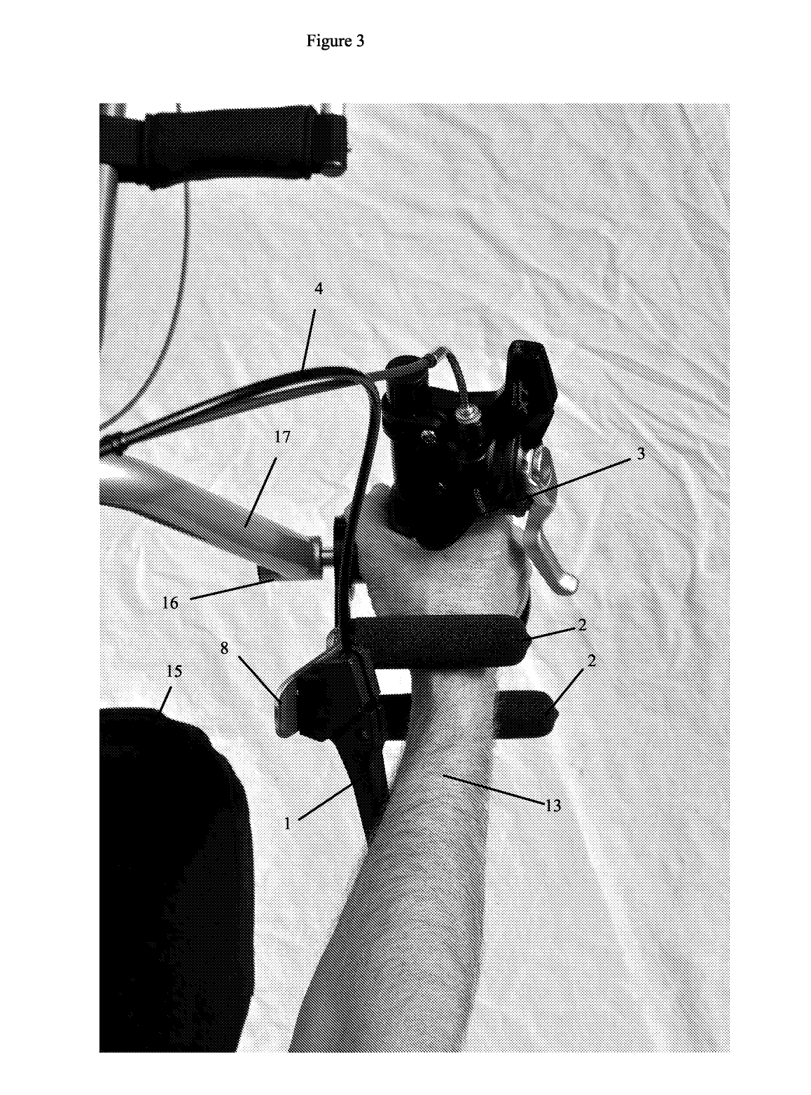

FIG. 3. shows the brake lever engaged with the forearm.

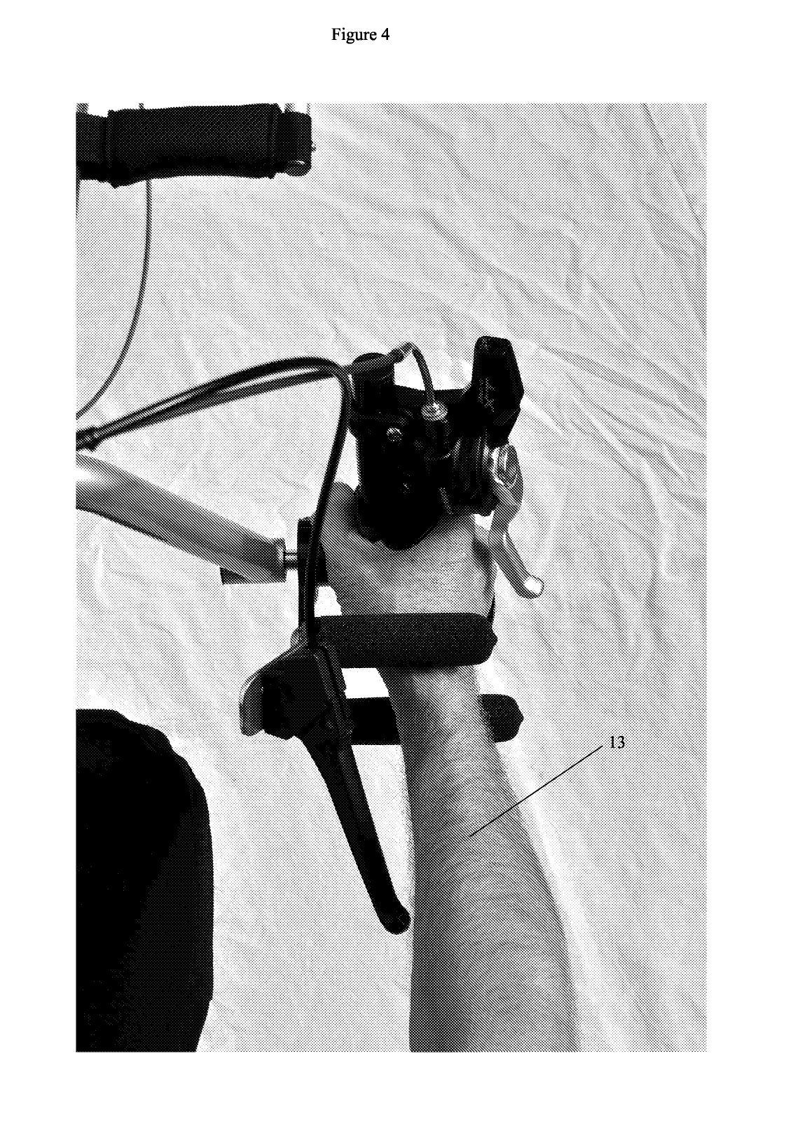

FIG. 4. shows the brake lever with the forearm moved away from the lever in the riding or non-brake position.

FIG. 1 shows the preferred embodiment of the present invention with brake lever 1 attached to the handcycle. Cable housing and cable 4 are attached to brake lever 1 and connect to the disc brake caliper (not shown) on the opposite side of the front wheel. Pedal 3 and quad grips 2 are available for the operator to secure their hands on grip 3. In FIG. 2 brake lever base 5 is pivotally mounted to plate 8 by bolt and nut 9. Bolt and nut 9 may be loosened to permit brake lever base 5 to be rotated about the axis of bolt and nut 9 to permit adjustment of the position of brake lever 1. The brake cable is secured into brake lever 1 by cable stop 6 in brake lever 1 and brake lever 1 is permitted to rotate about pivot point 7 to permit movement of brake lever 1 and movement of brake cable inside of brake cable housing 4. Plate 8 is connected to pedal support plate 11 by cap screw 10. Cap screw 10 is inserted into quad grip pin 2 and permits rotation of plate 8 about bolt 10 to permit adjustment of brake lever 1 and plate 8 relative to plate 11. Places of adjustment 9 ad 10 allow lever 1 to be properly aligned for positioning of the operator's arms for actuation of the brake lever 1 and engagement of the cycle's brake as will be seen in FIGS. 3 and 4.

In FIG. 3 arm 13 is shown pressing against brake lever 1 actuating brake cable inside cable housing 4 and actuating the disc brake on the handcycle of FIG. 1. Pedal 3 is attached to crank arm bearings (not shown) in end of crank arm 17.

In FIG. 4 arm 13 is away from brake lever 1 and cable inside of cable housing 4 is in the relaxed, non-tensioned position and the disc brake is not engaging the disc and the wheel is allowed to rotate freely.

In order to make use of the preferred embodiment of the present invention the operator places himself on the seat 15 of the handcycle and engages the pedal 3 with his hand. The two pins 2 allow the operator to pull against the pedal 3 without his hands coming free of the pedal 3 grip. The pins 2 are important for individuals with high level injuries because they allow the person to keep their hands on the pedal 3. Individuals with high level injuries often times do not have the ability to squeeze with their fingers and can not squeeze the brake lever 1 toward the pedal 3 to apply braking pressure to a disc or caliper brake.

Individuals with high level injuries may have the ability to move their arm 13 inwardly or outwardly while their hands are secured to the pedal 3 by the pins 2 or by other securing means. In the preferred embodiment of the present invention it does not matter how the operator's hand is secured to pedal 3. The pins 2 are one way of securing the operator's hand to the pedal 3. This inward or outward movement of their arm 13 allows them to engage the brake lever 1. In the present preferred embodiment the arm is moved inwardly to engage brake lever 1 causing it to pivot about pivot point 7 stretching brake cable secured by cable end 6 and located inside cable housing 4 to engage the disc or other brake on the handcycle shown in FIG. 1.

The invention is suitable for other applications encountered by quadriplegics. The invention is a lever to be engaged by a person's arm or wrist with the purpose of causing tensile force in a cable for the purpose of moving a remote object such a brake caliper. The invention is the engagement of the lever by the person's forearm. The tensile force enacted upon the cable by the movement of the lever by the person's arm or wrist could also be used to open a throttle on a powered cycle. The lever could be mounted on the handlebars of a cycle in proximity of the operator's arm and wrist so that movement of the operator's arm would engage the lever and accelerate or stop the cycle.

The preferred embodiment of the present invention is the application of the arm actuated lever to a handcycle for the purpose of engaging a brake. This is only one of the possible embodiments of the invention.

1. A multi wheeled cycle configured to carry a rider including a frame configured to engage the {operator's} rider's body;
a pair of leg supports configured to engage the {operator's}rider's legs and feet;
a seat associated with said frame configured to engage the rider;
a pair of crank arms configured to rotate and provide at least one source of power for moving the cycle;
said crank arms including a pair of hand pedals configured to be engaged by the rider's hands;
a braking means configured to engage at least one wheel of said cycle for the purpose of slowing or stopping the cycle;
a brake lever attached at a location of the hand pedal such that rotation of said crank arms and said hand pedals enables rotation of said brake lever in synchronization with at least one hand pedal;
said brake lever further configured to be engaged by the rider's forearm or wrist for the purpose of engaging said brake lever when the rider moves his forearm or wrist inwardly or outwardly against the said brake lever such that the movement of said brake lever stops or slows said cycle.

2. The cycle as in claim {one} 1 where said brake lever is located such that the rider's arm and wrist engage said brake lever and inward motion of the rider's arm and wrist move said brake lever resulting in the slowing or stopping of said cycle.

3. The cycle as in claim {one} 1 where said brake lever is located such that the rider's arm and wrist engage said brake lever and outward motion of the rider's arm and wrist move said brake lever resulting in the slowing or stopping of said cycle.

4. A multi wheeled cycle configured to carry a rider including a frame configured to engage the operator's body;
a pair of leg supports configured to engage the operator's legs and feet;
a seat associated with said frame configured to engage the rider;
a pair of handles configured to be engaged by the rider's hands;
a braking means configured to engage at least one wheel of said cycle for the purpose of slowing or stopping the cycle;
a brake lever attached at a location in proximity of at least one of said handles such that said brake lever may be engaged by at least one of operator's arms;
said brake lever further configured to be engaged by the rider's forearm or wrist for the purpose of engaging said brake lever when the rider moves his forearm or wrist inwardly or outwardly against said brake lever such that the movement of said brake lever stops or slows said cycle.
